(19) United States
(12) Patent Application Publication
(10) Pub. No.: US 2026/0326148 A1
(43) Pub. Date: Oct. 22, 2026

(54) ACOUSTIC LEVITATION SYSTEM, COMPUTER-IMPLEMENTED METHOD FOR LEVITATING AN OBJECT, COMPUTER PROGRAM AND NON-VOLATILE DATA CARRIER

(71) Applicant: MYVOX AB, Stockholm (SE)

(72) Inventor: Josef HANSSON, Vällingby (SE)

(73) Assignee: MYVOX AB, Stockholm (SE)

(21) Appl. No.: 19/113,081

(22) PCT Filed: Aug. 7, 2023
(86) PCT No.: PCT/SE2023/050784

§ 371 Date: Mar. 19, 2025

(30) Foreign Application Priority Data
Oct. 4, 2022 (SE) 2251149-7

(51) Int. Cl. B06B 1/02; G01B 7/06; G01B 11/02; G01B 11/06; G10K 11/34; G10K 15/02

(52) U.S. Cl. CPC B06B 1/0276; G01B 7/102; G01B 11/022; G01B 11/0608; G10K 11/343; G10K 11/346; G10K 11/348; G10K 15/02; B06B 2201/20; G10K 2200/10

(57) ABSTRACT

Acoustic transducer elements emit acoustic energy of periodically varying intensity, such that emitted acoustic energy forms a standing wave pattern in a fluid medium adjoining a reflective surface. The standing wave pattern is created by interference between acoustic waves incident and reflected from the reflective surface and has regions with a resulting force field whose magnitude is different at different perpendicular distances from the reflective surface.

The emitted acoustic energy is based on at least one frequency component to form the standing wave pattern. The transducer elements are alternatively switched on and off, so that the acoustic energy is exclusively emitted when the at least one frequency component produces the resulting force field such that the resulting force field is directed in a consistent direction perpendicular to the reflective surface at a surface of an object located in the standing wave pattern.

### TECHNICAL FIELD

The present invention relates generally to contactless movement of objects. Especially, the invention relates to an acoustic levitation system for moving an object relative to a reflective surface according to the preamble of claim 1 and a corresponding computer-implemented method. The invention also relates to a computer program and a non-volatile data carrier storing such a computer program.

### BACKGROUND

Analogous to optic waves, acoustic waves can create radiation forces. At certain points where these forces converge traps can be created in which particles may be levitated in a stable manner. Such traps can be formed in standing wave fields in various configurations of emitter elements, for example a single sided phased array emitter emitting acoustic wave energy against an acoustically reflective surface as shown in WO 2009/106282. Acoustic traps may also be created between opposing phased array emitters as disclosed in US 2019/0108829; or by a single sided phased array emitter radiating into open space, i.e. without any nearby reflective surface, for example as described in Andrade, M. A. B., et al., “Acoustic Levitation in Mid-Air: Recent Advances, Challenges, and Future Perspectives”, Appl. Phys. Lett. 116, 250501(2020 ), published online 22 Jun. 2020.

Using a single sided emitter against a reflective surface creates traps at the nodes of a standing wave pattern caused by interference between the incident and reflected acoustic waves. Here, it is possible to manipulate the trap position in a plane being parallel to the reflecting surface by adjusting a focus point where the waves from several transducers interfere constructively. The plane that is parallel to the reflecting wall is often referred to as the x-y plane.

By using two opposing phased array emitters, or four phased array emitters being mutually opposing, the trap position can be manipulated in three dimensions. This may be effected by adjusting the focus point and adding a 180° phase delay on the relatively opposing arrays.

By using a single-sided phased array emitter radiating into open space, it is possible to create trap positions by holographically combining phase delays for a focus point with a trap signature. For instance, a tweezer-like twin trap may be produced consisting of two high-pressure regions of opposite phase, which create a trap in between. Alternatively, a vortex trap may be produced, which has a rotating phase around a phase singularity, creating a trap at the point of the singularity. Further, it is possible to create multiple focus points and control their relative phases by using a backpropagation algorithm. This allows for simultaneous manipulations of multiple particles. Here, the single array twin and vortex traps may be recreated by choosing the right focus points and relative phases as described in A. Marzo and B. W. Drinkwater, “Holographic Acoustic Tweezers”, PNAS, Vol. 116, No. 1, pp 84-89, 2 Jan. 2019.

Consequently, solutions are known for creating acoustic traps in which objects may be caught and moved without contact in various ways.

Manipulating particles in three dimensions using the prior-art technology has required either opposing arrays, or a free-field single sided array. Unfortunately, these kinds of arrangements are impractical to apply for manipulating small objects or particles. In actual applications it would more useful to be able to pick up a particle from a surface and then manipulate it from there.

However, the interference between incident and reflected acoustic wave prevents the formation of traps at any locations except for at fixed distances from the surface. This is a major barrier to many potential applications for acoustic levitation.

Specifically, in the known solutions, it is impossible to adjust the position of such a trap in a dimension being perpendicular to the acoustically reflecting surface in a reliable and flexible manner. Namely, in this perpendicular direction, the trap positions are given by the relationship λ(1/4+n/2), where λ is the wavelength of the acoustic wave energy being used and n denotes a trap number.

Moreover, once an object is held in a trap position it is difficult to move the object continuously to another trap position. In other words, moving objects laterally with respect to an acoustically reflecting surface is very challenging. This, in turn, is unfortunate because many technical implementations involve picking up and relocating objects near an acoustically reflecting surface, for example in the form of a printed circuit board (PCB) or similar structure onto which the objects in question are to be mounted.

WO 2022/132002 describes an acoustic levitation system that contains an acoustic transducer array emitting acoustic energy of periodically varying intensity. The acoustic transducer array includes a set of transducer elements arranged on a surface extending in two dimensions. The transducer elements are controllable in response to a control signal so as to emit the acoustic energy at a wavelength and a phase delay determined by the control signal. A controller generates the control signal such that interfering incident and reflected waves of the acoustic energy emitted towards an acoustically reflective surface form an effective standing wave pattern, where first and second pressure maximum regions are created at first and second distances respectively from the acoustically reflective surface, which first and second pressure maximum regions are of opposite phase to one another, and a pressure minimum point is created between the first and second pressure maximum regions. This is advantageous because the first and second pressure maximum regions may be created at any first and second distances respectively from the acoustically reflective surface. Consequently, an object can be trapped and transported an arbitrary orthogonal distance from the acoustically reflective surface.

However, it is still challenging to pick up objects from the acoustically reflective surface, and/or control the positioning of objects in close proximity thereto.

### SUMMARY

The object of the present invention is therefore to offer a solution that mitigates the above problem and renders it possible to levitate items at high precision with respect to the distance to a reflective surface using acoustic wave energy.

According to one aspect of the invention, the object is achieved by an acoustic levitation system containing at least one acoustic transducer element and a controller. The at least one acoustic transducer element is configured to emit acoustic energy of periodically varying intensity, and is controllable in response to at least one control signal so as to emit the acoustic energy at an amplitude, a wavelength and a phase delay defined by the at least one control signal. The controller is configured to generate the at least one control signal such that the emitted acoustic energy forms a standing wave pattern in a fluid medium adjoining a reflective surface in front of the at least one acoustic transducer element. The standing wave pattern is created by interference between acoustic waves incident and reflected from the reflective surface, and the standing wave pattern contains regions with a resulting force field whose magnitude is different at different perpendicular distances from the reflective surface. In particular, the controller is configured to generate the at least one control signal such that the emitted acoustic energy is based on at least one frequency component to form the standing wave pattern, and the emitted acoustic energy is alternately switched on and off so that the acoustic energy is exclusively emitted when the at least one frequency component produces the resulting force field in such a manner that the resulting force field is directed in a consistent direction being perpendicular to the reflective surface at a surface of an object located in the standing wave pattern.

The above acoustic levitation system is advantageous because it enables continuous manipulation of an object with respect to the object's distance to a reflective surface. Consequently, small-sizes objects may be lifted up from a supporting surface and/or be pushed up from below to a downward facing surface. This is very useful, for instance when positioning electronic components on a PCB, handling caustic liquids, poisonous agents, hot plasmas, or whenever hazardous entities shall be manipulated in a safe and controlled manner.

According to one embodiment of this aspect of the invention, the emitted acoustic energy is based on first and second frequency components and the controller is configured to generate the at least one control signal such that acoustic energy based on the first frequency component is emitted whenever the first frequency component produces the resulting force field in such a manner that the resulting force field is directed in the consistent direction being perpendicular to the reflective surface at a surface of an object located in the standing wave pattern. Analogously, the controller is configured to generate the at least one control signal such that acoustic energy based on the second frequency component is emitted whenever the second frequency component produces the resulting force field in such a manner that the resulting force field is directed in the consistent direction being perpendicular to the reflective surface at the surface of the object in the standing wave pattern. Thereby, by selecting a relationship between the first and second frequency components in terms of amplitude, frequency and/or phase delay, the characteristics of the resulting force field may be designed for efficient manipulation of small-sized objects near the reflective surface.

According to another embodiment of this aspect of the invention, the emitted acoustic energy is further based on a third frequency component, and the controller is configured to generate the at least one control signal such that acoustic energy based on the third frequency component is emitted whenever the third frequency component produces the resulting force field in such a manner that the resulting force field is directed in the consistent direction being perpendicular to the reflective surface at the surface of the object being located in the standing wave pattern, and otherwise, no acoustic energy is emitted that is based on the third frequency component. This is advantageous because the third frequency component allows for further tailoring of the characteristics of the resulting force field.

According to yet another embodiment of this aspect of the invention, the controller is configured to generate the at least one control signal such that, the standing wave pattern contains a first region at the reflective surface in which first region the standing wave pattern produces a first resulting force field that is directed in the consistent direction being perpendicular to the reflective surface at the surface of the object being located in the standing wave pattern. Consequently, the resulting force field may have a peak magnitude at the reflective surface, which, in turn, is highly beneficial when manipulating objects, for example to position components on a PCB.

According to still another embodiment of this aspect of the invention, the controller is configured to generate the at least one control signal such that the standing wave pattern contains a second region adjoining the first region in which second region the standing wave pattern does not produce any resulting force. The standing wave pattern also contains a third region, in turn, adjoining the second region in which third region the standing wave pattern produces a second resulting force field that is directed in the consistent direction being perpendicular to the reflective surface at the surface of the object being located in the standing wave pattern. Moreover, depending on whether the standing wave pattern is designed to move objects towards or away from the reflective surface, an interrelationship between respective magnitudes of the first and second resulting force fields and an extension of the second region in a direction perpendicular to the reflective surface is either such that:
(a) the object is repelled from the reflective surface by the first force field in the first region and is accelerated therein to a velocity being sufficient for transporting the object through the second region and be picked up by the second resulting force field in the third region, or
(b) the object is drawn towards the reflective surface by the second resulting force field in the third region and is accelerated therein to a velocity being sufficient for transporting the object through the second region and be picked up by the first resulting force field in the first region respectively.

This type of multilayer regions of force fields is advantageous because it enables objects to be moved across larger distances in relation to the reflective surface. Of course, an arbitrary number of further layers of force fields may be added. For example, according to one embodiment of this aspect of the invention, the controller is configured to generate the at least one control signal such that the standing wave pattern contains a fourth region, in turn, adjoining the third region in which fourth region the standing wave pattern does not produce any resulting force, Additionally, the controller is configured to generate the at least one control signal such that the standing wave pattern contains a fifth region, in turn, adjoining the fourth region in which fifth region the standing wave pattern produces a third resulting force field directed in the consistent direction being perpendicular to the reflective surface at the surface of the object located in the standing wave pattern. Analogous to the above, depending on whether the standing wave pattern is designed to move objects towards or away from the reflective surface, an interrelationship between respective magnitudes of the second and third resulting force fields and an extension of the fourth region in the consistent direction being perpendicular to the reflective surface is either such that:
(c) the object being repelled from the reflective surface and being picked up by the second resulting force field in the fourth region is accelerated therein to a velocity being sufficient for transporting the object through the fourth region and be picked up by the third resulting force field in the fifth region, or
(d) the object being drawn towards the reflective surface and being picked up by the third resulting force field in the fifth region is accelerated therein to a velocity being sufficient for transporting the object through the fourth region and be picked up by the second resulting force field in the third region respectively.

According to still another embodiment of this aspect of the invention, the controller is configured to generate the at least one control signal such that an amplitude of the standing wave pattern is constant in each point in the fluid medium adjoining the reflective surface in front of the at least one acoustic transducer element while the acoustic energy is emitted. This is beneficial if the size/density properties of the objects to be levitated are known in advance.

Alternatively, if, however, the size/density properties of the objects to be levitated are not known with sufficiently high accuracy, according to one embodiment of this aspect of the invention, the acoustic levitation system further contains a position sensor configured to obtain data reflecting a position of the object relative to the reflective surface. Here, the controller is configured to generate the at least one control signal such that the standing wave pattern varies in response to the position of the object relative to the reflective surface. The position sensor may include an image sensor, a laser sensor and/or a magnetic-field sensor.

Thus, the standing wave pattern can be varied dynamically to move the object as desired in the fluid medium.

According to another aspect of the invention, the object is achieved by a computer-implemented method for levitating an object relative to an acoustically reflective surface, which method is implemented in at least one processing circuitry. The method involves generating at least one control signal to at least one acoustic transducer element that is configured to emit acoustic energy of periodically varying intensity. The emitted acoustic energy is controllable in response to the at least one control signal in terms of amplitude, wavelength and phase delay. The at least one control signal is generated such that the emitted acoustic energy forms a standing wave pattern in a fluid medium adjoining a reflective surface in front of the at least one acoustic transducer element. The standing wave pattern is created by interference between acoustic waves incident and reflected from the reflective surface, and contains regions with a resulting force field whose magnitude is different at different perpendicular distances from the reflective surface. Specifically, the method involves generating the at least one control signal such that the at least one acoustic transducer element emits acoustic energy based on at least one frequency component to form the standing wave pattern, and the acoustic energy is alternately switched on and off so that it is exclusively emitted when the at least one frequency component produces the resulting force field in such a manner that the resulting force field is directed in a consistent direction being perpendicular to the reflective surface at a surface of an object located in the standing wave pattern. The advantages of this method, as well as the preferred embodiments thereof, are apparent from the discussion above with reference to the system.

According to a further aspect of the invention, the object is achieved by a computer program loadable into a non-volatile data carrier communicatively connected to a processing unit. The computer program includes software for executing the above method when the program is run on the processing unit.

According to another aspect of the invention, the object is achieved by a non-volatile data carrier containing the above computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows an acoustic levitation system according to a first embodiment of the invention;

FIGS. 2a-b illustrate how a standing wave pattern is formed based on two frequency components according to one embodiment of the invention;

FIG. 3a shows how layered regions the standing wave pattern are formed near a reflective surface according to one embodiment of the invention;

FIG. 3b illustrates how an object may be levitated through the layered regions of FIG. 3a according to one embodiment of the invention;

FIG. 4 illustrates how a standing wave pattern is formed based on a single frequency component according to one embodiment of the invention;

FIGS. 5a-b illustrate how a standing wave pattern is formed based on three frequency components according to one embodiment of the invention;

FIGS. 6-8 show acoustic levitation system according to second, third and fourth embodiments of the invention; and

FIG. 9 illustrates, by means of a flow diagram, the general method according to the invention.

### DETAILED DESCRIPTION

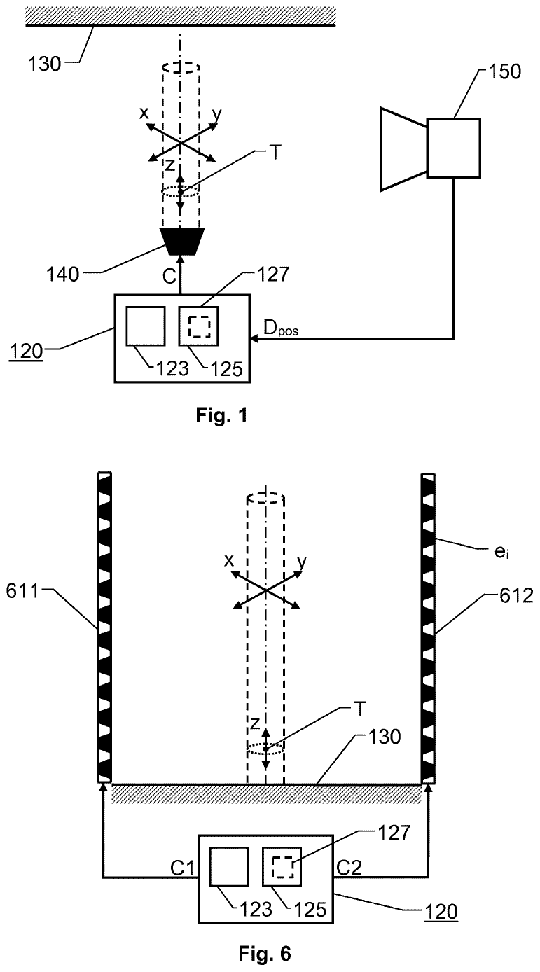

In FIG. 1, we see an acoustic levitation system according to a first embodiment of the invention. The acoustic levitation system includes an acoustic transducer element 140 and a controller 120.

The acoustic transducer element 140, which is configured to emit acoustic energy of periodically varying intensity, is controllable in response to a control signal C so as to emit the acoustic energy at an amplitude, a wavelength and a phase delay defined by the control signal C.

The controller 120 is configured to generate the control signal C such that the acoustic energy emitted from the acoustic transducer element 140 forms a standing wave pattern in a fluid medium adjoining a reflective surface 130, which, in turn, is located in front of the acoustic transducer element 140.

Typically, the fluid medium is a gas, e.g. air. However, the fluid medium adjoining the reflective surface 130 may equally well be a liquid, for example in the form of water. In any case, the standing wave pattern is created by interference between acoustic waves incident and reflected from the reflective surface 130, and the standing wave pattern contains regions with a resulting force field whose magnitude is different at different perpendicular distances from the reflective surface 130.

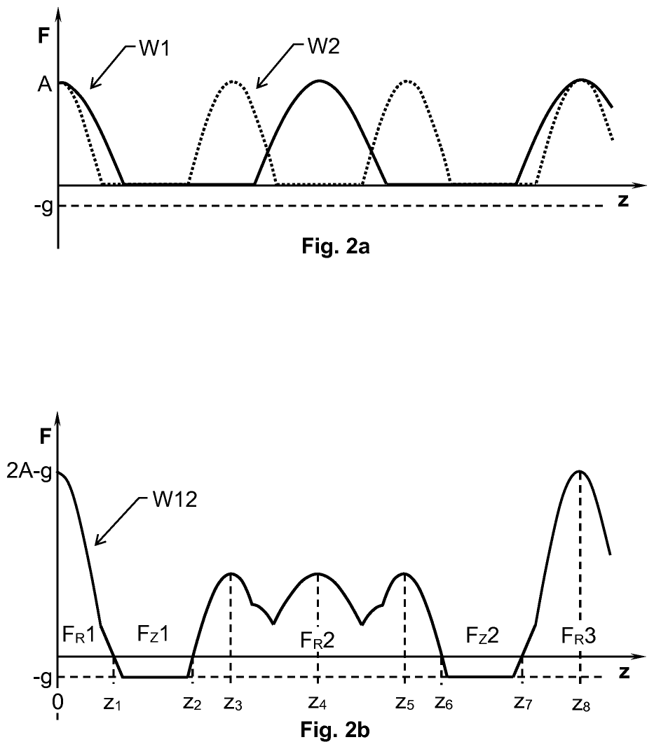

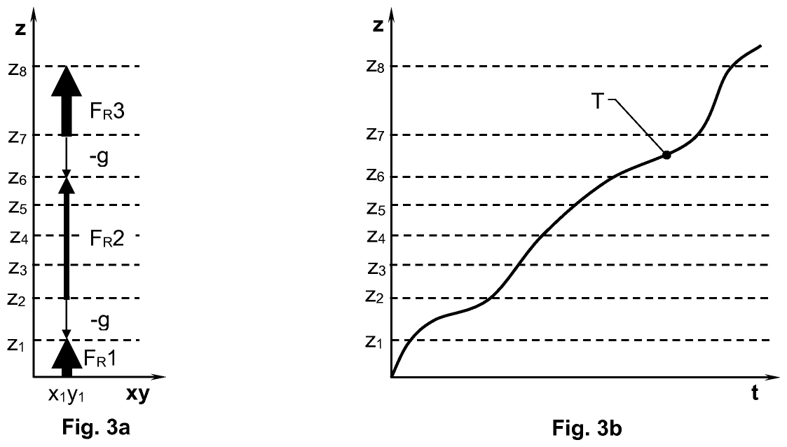

The controller 120 is configured to generate the control signal C such that the acoustic energy emitted from the acoustic transducer element 140 is based on at least one frequency component to form the standing wave pattern. This will be exemplified below with reference to FIGS. 2a, 2b, 3a and 3b.

FIGS. 2 a and 2 b represent a force field F as a function of a distance z from the reflective surface 130, where the force field F results from a first frequency component W1 and a second frequency W2 emitted from the acoustic transducer element 140, which first and second frequency components W1 and W2 respectively each has an amplitude A.

The controller 120 is specifically configured to generate the control signal C such that the acoustic transducer element 140 is alternately switched on and off so that the acoustic energy is exclusively emitted therefrom when a first frequency component W1 and/or a second frequency W2 produces the resulting force field F in such a manner that the resulting force field F is directed in a consistent direction being perpendicular to the reflective surface 130 at a surface of an object T located in the standing wave pattern. In other words, if, at a distance z from the reflective surface 130, the resulting force field F is directed straight towards the reflective surface 130 or straight away from the reflective surface 130, the acoustic transducer element 140 is on, and otherwise it is off.

In the example illustrated in FIG. 1, we assume that the reflective surface 130 is oriented horizontally, said consistent direction is oriented vertically and the controller 120 generates the control signal C such that the resulting force field F is directed straight upwards towards reflective surface 130. Thus, the gravity force field g is directed opposite to the resulting force field F. Of course, any alternative orientation of the reflective surface 130 is likewise conceivable according to the invention. For example, the acoustic transducer element 140 may be positioned above the reflective surface 130, which is horizontally oriented, and the controller 120 may generate the control signal C such that the resulting force field F is directed straight upwards away from reflective surface 130.

The acoustic transducer element 140 is configured to emit acoustic energy of periodically varying intensity, i.e. sound waves, at for example a frequency in an interval between 30 kHz and 300 kHz. In FIG. 2 a, at any distance z, where one or both of the first and second frequency components W1/W2 would have a negative resulting force field F, the acoustic transducer element 140 is off/inactive.

FIG. 2 b illustrates the force field F resulting from the first and second frequency components W1 and W2 and gravity g. As can be seen, the standing wave pattern contains a first region F_{R}1 where the force field F has a maximal amplitude of 2 A-g, extending from the reflective surface 130 to a first distance z₁ therefrom. In the first region F_{R}1, the standing wave pattern produces a first resulting force field being directed towards the reflective surface 130.

In a second region F_{Z}1, adjoining the first region F_{R}1 and extending from the first distance z₁ to a second distance z₂ from the reflective surface 130, there is no resulting force field produced by the acoustic transducer element 140. Hence, in the second region F_{Z}1, exclusively gravity g acts on any object being located there.

In a third region F_{R}2, adjoining the second region F_{Z}1 and extending from the second distance z₂ to a sixth distance z₆ from the reflective surface 130, the force field F resulting from the first and second frequency components W1 and W2 minus gravity g is positive. In the third region F_{R}2, the resulting force field F has three peaks at third, fourth and fifth distances z₃, z₄, and z₅ respectively from the reflective surface 130, which distances z₃, z₄, and z₅ correspond to maxima in the first and second frequency components W1 and W2.

In a fourth region F_{Z}2, adjoining the third region F_{R}2 and extending from the sixth distance ze to a seventh distance z₇ from the reflective surface 130, there is no resulting force field produced by the acoustic transducer element 140. Hence, analogous to the second region F_{Z}1, exclusively gravity g acts on any object being located in the fourth region F_{Z}2.

In a fifth region F_{R}3, adjoining the fourth region F_{Z}2 and extending from the seventh distance z₇, the force field F resulting from the first and second frequency components W1 and W2 minus gravity g is again positive. Depending on how far away from the reflective surface 130 the object T is to be levitated, the controller 120 may generate the control signal C such that the characteristics of the force field in the first region F_{R}1 are repeated at an eight distance za from the reflective surface 130, and so on.

In the example shown in FIGS. 2a and 2b, the frequency component W1 may be 120 kHz and the second frequency component W2 may be 180 KHz.

It should be noted that in this disclosure, the wording “consistent perpendicular direction” is understood to designate the fact that, in a given implementation, the resulting force field F is directed in the same direction at all distances z from the reflective surface 130.

According to one embodiment of the invention, the emitted acoustic energy is based on the first and second frequency components W1 and W2 respectively, and the controller 120 is configured to generate the control signal C such that acoustic energy based on the first frequency component W1 is emitted whenever the first frequency component W1 produces the resulting force field F in such a manner that the resulting force field F is directed in a consistent direction being perpendicular to the reflective surface 130 at a surface of an object T being located in the standing wave pattern. Analogously, the controller 120 is configured to generate the control signal C such that acoustic energy based on the second frequency component W2 is emitted whenever the second frequency component W2 produces the resulting force field F in such a manner that the resulting force field F is directed in the consistent direction being perpendicular to the reflective surface 130 at the surface of the object T when being located in the standing wave pattern. This results in a characteristics of the standing wave pattern as described above with

Reference to FIGS. 2a, 2b and 3a.

According to one embodiment of the invention, the controller 120 is configured to generate the control signal such that C, in the fluid medium, the standing wave pattern W12 contains the first region F_{R}1 at the reflective surface 130 in which first region F_{R}1 the standing wave pattern W12 produces a first resulting force field directed either towards or away from the reflective surface 130.

Further, the controller 120 may be configured to generate the control signal C such that the fluid medium contains the second region F_{Z}1 adjoining the first region F_{R}1 in which second region F_{Z}1 the standing wave pattern W12 does not produce any resulting force; the standing wave pattern contains a third region F_{R}2 adjoining the second region F_{Z}1 in which third region F_{R}2 the standing wave pattern W12 produces a second resulting force field directed either towards or away from the reflective surface 130. Moreover, an interrelationship between respective magnitudes of the first and second resulting force fields and an extension of the second region F_{Z}1 in the direction perpendicular z to the reflective surface 130 is such that an object T that is repelled from the reflective surface 130 by the first force field in the first region F_{R}1 is accelerated therein to a velocity being sufficient for transporting the object T through the second region F_{Z}1 and be picked up by the second resulting force field in the third region F_{R}2. Similarly, if instead the design is such that the object T is to be drawn towards the reflective surface 130, the controller 120 generates the control signal C such that the second resulting force field in the third region F_{R}2 causes the object T to be accelerated therein to a velocity being sufficient for transporting the object T through the second region F_{Z}1 and be picked up by the first resulting force field in the first region F_{R}1.

According to one embodiment of the invention, the controller 120 is configured to generate the control signal C such that the standing wave pattern further contains fourth and fifth regions F_{Z}2 and F_{R}3 respectively. Here, the fourth region F_{Z}2 adjoins the third region F_{R}2 as described above with reference to FIGS. 2b and 3a, and in the fourth region F_{Z}2 the standing wave pattern W12 does not produce any resulting force. The fifth region F_{R}3 adjoins the fourth region F_{Z}2 as described above with reference to FIGS. 2b and 3a, and in the fifth region F_{R}3 the standing wave pattern W12 produces a third resulting force field directed either towards or away from the reflective surface 130. Additionally, an interrelationship between respective magnitudes of the second and third resulting force fields and an extension of the fourth region in the direction perpendicular z to the reflective surface 130 is such that if the design is such that the object T is to be repelled from the reflective surface 130 and be picked up by the second resulting force field in the fourth region F_{Z}2, the second resulting force field has such magnitude that the object T is accelerated fourth region F_{Z}2 to a velocity being sufficient for transporting the object T through the fourth region F_{Z}2 and be picked up by the third resulting force field in the fifth region F_{R}3. Alternatively, if instead the acoustic levitation system is designed to transport objects in the opposite direction relative to the reflective surface 130, the interrelationship between respective magnitudes of the second and third resulting force fields and an extension of the fourth region in the direction perpendicular z to the reflective surface 130 is such that an object T being drawn towards the reflective surface 130 and picked up by the third resulting force field in the fifth region F_{R}3 is accelerated therein to a velocity being sufficient for transporting the object T through the fourth region F_{Z}2 and be picked up by the second resulting force field in the third region F_{R}2.

FIG. 3 b shows a graph illustrating how the object T may be levitated through the above-described layers of regions F_{R}1, F_{Z}1, F_{R}2, F_{Z}2 and F_{R}3. The graph shows the perpendicular distance z along the vertical axis and time t along the horizontal axis. Although, of course, the temporal process may vary due to many factors, the object T typically travels slower through the second and fourth regions F_{Z}1 and F_{Z}2 respectively, where the object is exclusively exerted to gravity.

According to one embodiment of the invention, the controller 120 is configured to generate the control signal C such that an amplitude of the standing wave pattern is constant in each point in the fluid medium that adjoins the reflective surface 130 in front of the acoustic transducer element 140. This is generally advantageous if the physical characteristics of the object T to be levitated are well known, for instance in terms of its density and size.

If, however, less accurate data are available about the object T to be levitated, it is beneficial to control the acoustic transducer element 140 dynamically. Therefore, referring again to FIG. 1, according to one embodiment of the invention, the acoustic levitation system also includes a position sensor 150, which is configured to obtain data Dₚₒₛ reflecting a position of the object T relative to the reflective surface 130. The data Dₚₒₛ reflecting the position at least indicates the perpendicular distance z from the reflective surface 130. However, preferably, the data Dₚₒₛ also contains a position of the object T in a plane parallel to the reflective surface 130, e.g. coordinates expressing a two-dimensional position along axes x and y orthogonal to the z axis.

Here the controller 120 is configured to generate the control signal C such that the standing wave pattern varies in response to the position of the object T relative to the reflective surface 130. This means that the controller 120 generates the control signal C dynamically so that the object T is levitated in a desired manner through the standing wave pattern in the fluid medium.

Preferably, the position sensor 150 contains an image sensor, a laser sensor and/or a magnetic-field sensor that is configured to obtain the data Dₚₒₛ reflecting the position of the object T.

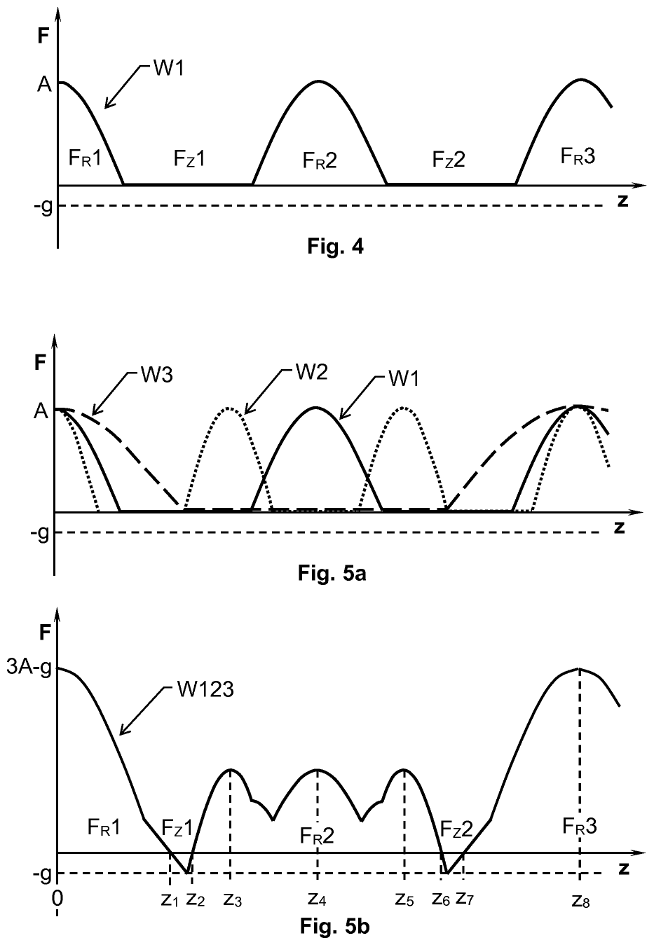

FIG. 4 illustrates a simplest possible embodiment of the invention, wherein the emitted acoustic energy only contains a single frequency component W1 of an amplitude A to form the standing wave pattern. Here, by necessity, the second and fourth regions F_{Z}1 and F_{Z}2 are comparatively large. Therefore, the respective magnitudes of the resulting force field F in the first and third regions F_{R}1 and F_{R}2 must be comparatively large in order to be able to transport an object T successfully through the standing wave pattern in the fluid medium.

FIGS. 5a and 5b illustrate one embodiment of the invention, wherein the emitted acoustic energy contains three frequency components W1, W2 and W3, each of a respective amplitude A, to form the standing wave pattern W123. In the first and third regions F_{R}1 and F_{R}2, the standing wave pattern W123 produces a force field F that has a maximal amplitude of 3 A-g. In contrast to the example described referring to FIG. 4, the second and fourth regions F_{Z}1 and F_{Z}2 are here comparatively small. Consequently, the respective magnitudes of the resulting force field F in the first and third regions F_{R}1 and F_{R}2 may be relatively small, and still an object T can be successfully transported through the standing wave pattern in the fluid medium.

Specifically, in addition to what has been described above with reference to FIGS. 2a, 2b, 3a and 3b, in the embodiment illustrated in FIGS. 5a and 5b, the controller 120 is configured to generate the control signal C such that acoustic energy based on the third frequency component W3 is emitted whenever the third frequency component W3 produces the resulting force field F in such a manner that the resulting force field F is directed in the consistent direction being perpendicular to the reflective surface 130 at the surface of the object T located in the standing wave pattern. Otherwise, i.e. at all other perpendicular distances z from the reflective surface 130, the controller 120 is configured to generate the control signal C such that no acoustic energy is emitted, which is based on the third frequency component W3.

FIG. 6 shows an acoustic levitation system according to a second embodiment of the invention. Here, the system contains first and second acoustic transducer arrays 611 and 621 respectively. Each of the first and second acoustic transducer arrays 611 and 621, in turn, includes a set of transducer elements eᵢ arranged on a surface. In this embodiment, the surface is flat and the transducer elements eᵢ are arranged in a first number of rows and a second number of columns. Consequently, it is comparatively straightforward to control the transducer elements eᵢ to create a desired standing wave pattern between the acoustic transducer array 110 and an acoustically reflective surface 130 parallel to the acoustic transducer array 110. Namely, the transducer elements eᵢ are controllable in response to first and second control signals C1 and C2 respectively so as to emit the acoustic energy at an amplitude, wavelength and phase delay determined by the first and second control signals C1 and C2.

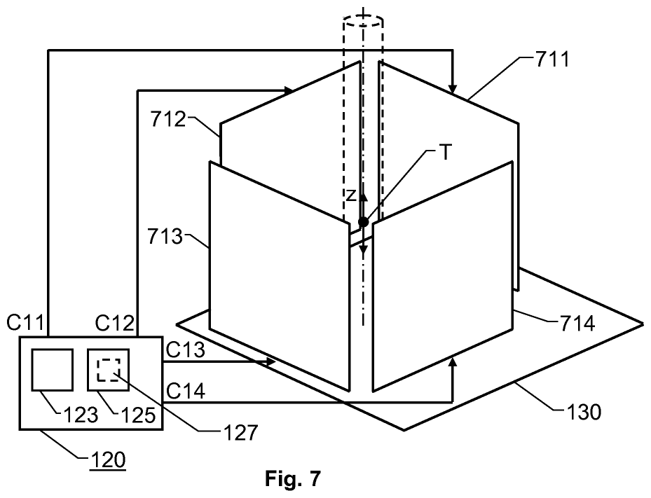

FIG. 7 shows an acoustic levitation system according to a third embodiment of the invention, where, basically, the setup of acoustic transducer arrays has been doubled relative to the embodiment shown in FIG. 6. Specifically, in the third embodiment of the invention, four acoustic transducer arrays 711, 712, 713 and 714 respectively are arranged pairwise opposite to one another.

The four acoustic transducer arrays 711, 712, 713 and 714 are arranged on a respective flat surface being pairwise parallel to the opposing array, i.e. here a first acoustic transducer array 711 is parallel to a third acoustic transducer array 513, and a second acoustic transducer array 712 is parallel to a fourth acoustic transducer array 714. Each of the flat surfaces is also orthogonal to the reflective surface 130.

Each of the acoustic transducer arrays 711, 712, 713 and 714 is configured to emit acoustic energy of periodically varying intensity. Each of the acoustic transducer arrays 711, 712, 713 and 714 also includes a set of transducer elements (not shown) arranged on a surface extending in two dimensions. The transducer elements of the acoustic transducer arrays 711, 712, 713 and 714 are controllable in response to a respective control signal C11, C12, C13 and C14 so as to emit the acoustic energy at a magnitude, wavelength and phase delay determined by the control signals C11, C12, C13 and C14.

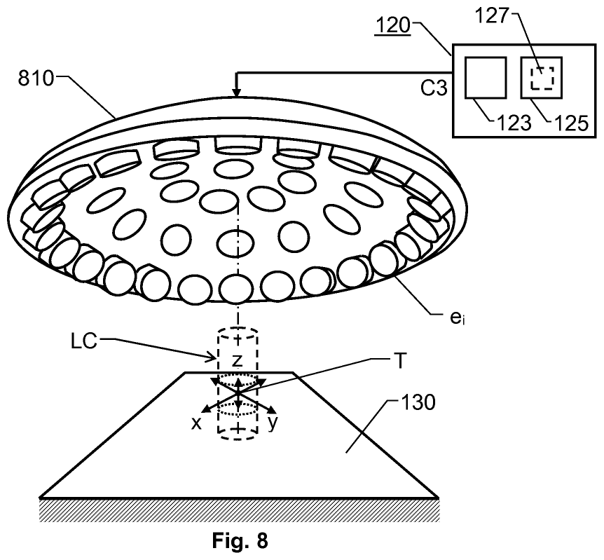

FIG. 8 shows an acoustic levitation system according to a fourth embodiment of the invention. Here, the transducer elements eᵢ in the acoustic transducer array 810 are arranged on a concave side of a spherical surface segment, i.e. a surface extending in three dimension. This configuration is advantageous because it enables a higher concentration of acoustic energy in front of the acoustic transducer array 810 so that heavier objects can be levitated than if the acoustic transducer array had extended along a flat—two-dimensional—surface.

In all the embodiments of the invention described above with reference to FIGS. 1 and 6 to 8 it is desirable if the controller 120 is configured to generate the control signal(s) C; C1, C2, C11, C12, C13, C14 and C3 respectively such that a position in an x-y plane relative to the acoustically reflective surface 130 varies over time. Namely, this constitutes a useful supplement to moving the entire acoustically reflective surface 130 relative to the acoustic transducer array(s).

It is generally advantageous if the controller 120 is configured to effect the above-described procedure in an automatic manner by executing a computer program 127. Therefore, the controller 120 may include a memory unit 126, i.e. non-volatile data carrier, storing the computer program 127, which, in turn, contains software for making processing circuitry in the form of at least one processor 123 in the controller 120 execute the actions mentioned in this disclosure when the computer program 127 is run on the at least one processor 123, and thus generate the control signal(s) C; C1, C2, C11, C12, C13, C14 and C3 respectively.

This namely enables placing and relocating items with respect to other items on the reflective surface 130. For example, electronic components may be placed on a PCB, caustic liquids, poisonous agents, hot plasmas or by other means hazardous entities may be handled safely.

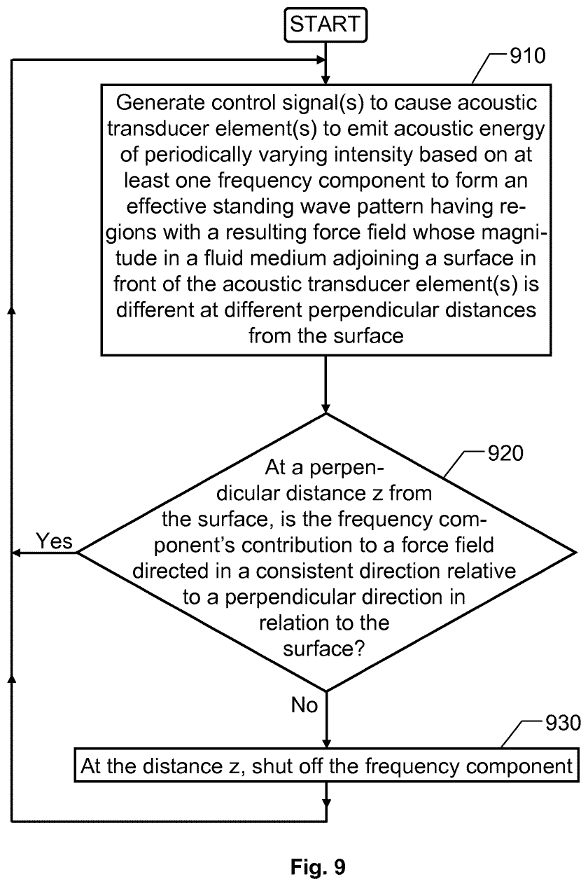

In order to sum up, and with reference to the flow diagram in FIG. 9, we will now describe the computer-implemented method according to one embodiment of the invention.

In a first step 910, at least one control signal is generated, which at least one control signal causes at least one acoustic transducer element to emit acoustic energy of periodically varying intensity. The emitted acoustic energy is based on at least one frequency component and is controlled by the at least one control signal in terms of amplitude, wavelength and phase delay. The emitted acoustic energy forms a standing wave pattern in a fluid medium adjoining a reflective surface in front of the at least one acoustic transducer element. The standing wave pattern is created by interference between acoustic waves incident and reflected from the reflective surface, and the standing wave pattern contains regions with a resulting force field whose magnitude is different at different perpendicular distances from the reflective surface.

A subsequent step 920, checks if, at a perpendicular distance z from the reflective surface, the at least one frequency component's contribution to a force field is directed in a consistent direction being perpendicular to the reflective surface at a surface of an object located in the standing wave pattern. If so, the procedure loops back to step 910, and otherwise a step 930 follows. In step 930, the frequency component is shut off at the distance z. Thereafter, the procedure loops back to step 910.

All of the process steps, as well as any sub-sequence of steps, described with reference to FIG. 9 may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal, which may be conveyed, directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. An acoustic levitation system comprising:
at least one acoustic transducer element configured to emit acoustic energy of periodically varying intensity, and controllable in response to at least one control signal so as to emit the acoustic energy at an amplitude, a wavelength and a phase delay defined by the at least one control signal; and
a controller configured to generate the at least one control signal such that the emitted acoustic energy forms a standing wave pattern in a fluid medium adjoining a reflective surface in front of the at least one acoustic transducer element, which standing wave pattern is created by interference between acoustic waves incident and reflected from the reflective surface, and which standing wave pattern comprises regions with a resulting force field whose magnitude is different at different perpendicular distances from the reflective surface,
wherein the controller is further configured to generate the at least one control signal such that the emitted acoustic energy:
is based on at least one frequency component to form the standing wave pattern, and
is alternately switched on and off so that the acoustic energy is exclusively emitted when the at least one frequency component produces the resulting force field in such a manner that the resulting force field is directed in a consistent direction being perpendicular to the reflective surface at a surface of an object located in the standing wave pattern.

2. The acoustic levitation system according to claim 1, wherein the emitted acoustic energy is based on first and second frequency components and the controller is configured to generate the at least one control signal such that:
acoustic energy based on the first frequency component is emitted whenever the first frequency component produces the resulting force field in such a manner that the resulting force field is directed in the consistent direction being perpendicular to the reflective surface at the surface of the object located in the standing wave pattern, and otherwise no acoustic energy is emitted that is based on the first frequency component, and
acoustic energy based on the second frequency component is emitted whenever the second frequency component produces the resulting force field in such a manner that the resulting force field is directed in the consistent direction being perpendicular to the reflective surface at the surface of the object located in the standing wave pattern, and otherwise no acoustic energy is emitted that is based on the second frequency component.

3. The acoustic levitation system according to claim 2, wherein the emitted acoustic energy is further based on a third frequency component and the controller is configured to generate the at least one control signal such that:
acoustic energy based on the third frequency component is emitted whenever the third frequency component produces the resulting force field in such a manner that the resulting force field is directed in the consistent direction being perpendicular to the reflective surface at the surface of the object located in the standing wave pattern, and otherwise no acoustic energy is emitted that is based on the third frequency component.

4. The acoustic levitation system according to claim 1, wherein the controller is configured to generate the at least one control signal such that the standing wave pattern comprises a first region at the reflective surface in which first region the standing wave pattern produces a first resulting force field directed in the consistent direction being perpendicular to the reflective surface at the surface of the object located in the standing wave pattern.

5. The acoustic levitation system according to claim 4, wherein the controller is configured to generate the at least one control signal such that:
the standing wave pattern comprises a second region adjoining the first region in which second region the standing wave pattern does not produce any resulting force,
the standing wave pattern comprises a third region adjoining the second region in which third region the standing wave pattern produces a second resulting force field directed either towards or away from the reflective surface and
an interrelationship between respective magnitudes of the first and second resulting force fields and an extension of the second region in a direction perpendicular to the reflective surface is such that:
said object is repelled from the reflective surface by the first force field in the first region and is accelerated therein to a velocity being sufficient for transporting the object through the second region and be picked up by the second resulting force field in the third region, or
said object is drawn towards the reflective surface by the second resulting force field in the third region and is accelerated therein to a velocity being sufficient for transporting the object through the second region and be picked up by the first resulting force field in the first region respectively.

6. The acoustic levitation system according to claim 5, wherein the controller is configured to generate the at least one control signal such that:
the standing wave pattern comprises a fourth region adjoining the third region in which fourth region the standing wave pattern does not produce any resulting force,
the standing wave pattern comprises a fifth region adjoining the fourth region in which fifth region the standing wave pattern produces a third resulting force field directed in the consistent direction being perpendicular to the reflective surface at the surface of the object T located in the standing wave pattern, and
an interrelationship between respective magnitudes of the second and third resulting force fields and an extension of the fourth region in the direction perpendicular to the reflective surface is such that:
the object being repelled from the reflective surface and being picked up by the second resulting force field in the fourth region is accelerated therein to a velocity being sufficient for transporting the object through the fourth region and be picked up by the third resulting force field in the fifth region, or
the object being drawn towards the reflective surface and being picked up by the third resulting force field in the fifth region is accelerated therein to a velocity being sufficient for transporting the object through the fourth region and be picked up by the second resulting force field in the third region respectively.

7. The acoustic levitation system according to claim 1, wherein the controller is configured to generate the at least one control signal such that an amplitude of the standing wave pattern is constant in each point in the fluid medium adjoining the reflective surface in front of the at least one acoustic transducer element while the acoustic energy is emitted.

8. The acoustic levitation system according to claim 5, further comprising:
a position sensor configured to obtain data reflecting a position of the object relative to the reflective surface, and
wherein the controller is configured to generate the at least one control signal such that the standing wave pattern varies in response to the position of the object relative to the reflective surface.

9. The acoustic levitation system according to claim 8, wherein the position sensor comprises at least one of an image sensor, a laser sensor and a magnetic-field sensor.

10. A computer-implemented method, which method is implemented in at least one processing circuitry and comprises:
generating at least one control signal to at least one acoustic transducer element that is configured to emit acoustic energy of periodically varying intensity, the emitted acoustic energy being controllable in response to the at least one control signal in terms of amplitude, wavelength and phase delay, and the at least one control signal being generated such that the emitted acoustic energy forms a standing wave pattern in a fluid medium adjoining a reflective surface in front of the at least one acoustic transducer element, which standing wave pattern is created by interference between acoustic waves incident and reflected from the reflective surface and which standing wave pattern comprises regions with a resulting force field whose magnitude is different at different perpendicular distances from the reflective surface, wherein characterized by the method comprising generating the at least one control signal is generated such that the at least one acoustic transducer element:
emits acoustic energy based on at least one frequency component to form the standing wave pattern; and
is alternately switched on and off so that the acoustic energy is exclusively emitted when the at least one frequency component produces the resulting force field in such a manner that the resulting force field is directed in a consistent direction being perpendicular to the reflective surface at a surface of an object located in the standing wave pattern.

11. The method according to claim 10, comprising:
emitting the acoustic energy based on first and second frequency components; and
generating the at least one control such that:
acoustic energy based on the first frequency component is emitted whenever the first frequency component produces the resulting force field in such a manner that the resulting force field is directed in the consistent direction being perpendicular to the reflective surface at the surface of the object located in the standing wave pattern, and otherwise no acoustic energy is emitted that is based on the first frequency component, and
acoustic energy based on the second frequency component is emitted whenever the second frequency component produces the resulting force field in such a manner that the resulting force field is directed in the consistent direction being perpendicular to the reflective surface at the surface of the object located in the standing wave pattern, and otherwise no acoustic energy is emitted that is based on the second frequency component.

12. The method according to claim 11, further comprising:
emitting acoustic energy based on a third frequency component; and
generating the at least one control signal such that:
acoustic energy based on the third frequency component is emitted whenever the third frequency component produces the resulting force field in such a manner that the resulting force field directed in the consistent direction being perpendicular to the reflective surface at the surface of the object located in the standing wave pattern, and
otherwise no acoustic energy is emitted that is based on the third frequency component.

13. The method according to claim 10, comprising:
generating the at least one control signal such that, the standing wave pattern comprises a first region at the reflective surface in which first region the standing wave pattern produces a first resulting force field directed in the consistent direction being perpendicular to the reflective surface at the surface of the object located in the standing wave pattern.

14. The method according to claim 13, comprising generating the at least one control signal such that:
the standing wave pattern comprises a second region adjoining the first region in which second region the standing wave pattern does not produce any resulting force,
the standing wave pattern comprises a third region adjoining the second region in which third region the standing wave pattern produces a second resulting force field directed away from the reflective surface, and
an interrelationship between respective magnitudes of the first and second resulting force fields and an extension of the second region in a direction perpendicular to the reflective surface is such that:
said object is repelled from the reflective surface by the first force field in the first region and is accelerated therein to a velocity being sufficient for transporting the object through the second region and be picked up by the second resulting force field in the third region, or
said object is drawn towards the reflective surface by the second resulting force field in the third region and is accelerated therein to a velocity being sufficient for transporting the object through the second region and be picked up by the first resulting force field in the first region respectively.

15. The method according to claim 14, comprising generating the at least one control signal such that:
the standing wave pattern comprises a fourth region adjoining the third region in which fourth region the standing wave pattern does not produce any resulting force,
the standing wave pattern comprises a fifth region adjoining the fourth region in which fifth region the standing wave pattern produces a third resulting force field directed either towards or away from the reflective surface, and
an interrelationship between respective magnitudes of the second and third resulting force fields and an extension of the fourth region in the direction perpendicular to the reflective surface is such that:
the object being repelled from the reflective surface and being picked up by the second resulting force field in the fourth region is accelerated therein to a velocity being sufficient for transporting the object through the fourth region and be picked up by the third resulting force field in the fifth region, or
the object being drawn towards the reflective surface and being picked up by the third resulting force field in the fifth region is accelerated therein to a velocity being sufficient for transporting the object through the fourth region and be picked up by the second resulting force field in the third region respectively.

16. The method according to claim 10, comprising generating the at least one control signal such that an amplitude of the standing wave pattern is constant in each point in the fluid medium adjoining the reflective surface in front of the at least one acoustic transducer element while the acoustic energy is emitted.

17. The method according to claim 14, comprising:
obtaining data reflecting a position of the object relative to the reflective surface; and
generating the at least one control signal such that the standing wave pattern varies in response to the position of the object relative to the reflective surface.

18. A computer program loadable into a non-volatile data carrier communicatively connected to a processing unit, the computer program comprising software for executing the method according to claim 10 when the computer program is run on the processing unit.

19. A non-volatile data carrier communicatively connected to a processing unit, said non-volatile data carrier comprising computer program software for executing the method according to claim 10 when the computer program is run on the processing unit.
